(19) United States
(12) Patent Application Publication
(10) Pub. No.: US 2020/0411841 A1
(43) Pub. Date: Dec. 31, 2020

(54) FURCATED TAB, ELECTRODE ASSEMBLY AND BATTERY

(71) Applicant: NINGDE AMPEREX TECHNOLOGY LIMITED, Ningde City (CN)

(72) Inventors: Ying SHAO, Ningde City (CN); Qiaoshu HU, Ningde City (CN); Bin WANG, Ningde City (CN); Xiang LI, Ningde City (CN)

(21) Appl. No.: 16/907,564

(22) Filed: Jun. 22, 2020

(30) Foreign Application Priority Data
Jun. 28, 2019 (CN) 201910574042.9

(51) Int. Cl. H01M 4/13; H01M 2/26; H01M 10/0525

(52) U.S. Cl. CPC H01M 4/13; H01M 10/0525; H01M 2/26

(57) ABSTRACT

A furcated tab includes a first furcated portion and a second furcated portion. The first furcated portion includes a first end, and the second furcated portion includes a second end. The second end is electrically connected to the first end. By changing the structure of the existing tab, the furcated tab effectively solve the problem where a lithium ion battery does not exert full battery capacity thereof due to the presence of a non-metal layer, when the existing tab is applied to a composite current collector.

### CROSS REFERENCE TO RELATED APPLICATIONS

The present application claims the benefit of priority from the Chinese Patent Application No. 201910574042.9, filed on 28 Jun. 2019, the disclosure of which is hereby incorporated by reference in its entirety.

### BACKGROUND

### 1. Field of the Invention

The present application relates to the technical field of electrochemical devices, and more particularly, to a furcated tab, an electrode assembly and a battery.

### 2. Description of the Related Art

The following descriptions and examples, though included in this section, are not to be considered as conventional technologies.

Lithium ion batteries have advantages such as high energy density, high operating voltage, low self-discharge rate, small size and light weight, and have wide application in the field of consumer electronics. However, with the rapid development of electric vehicles and mobile electronic devices, people pay more and more attention to the safety of battery. It is hoped not only that there will be no safety hazards during normal use, but also that even if the battery is damaged by severe impact, puncture, etc., the battery will not burn or explode.

A tab is a metal conductor that is electrically connected to a current collector in a lithium ion battery to direct electrical energy to an external circuit. Currently, the current collector used in lithium ion batteries is a metal foil (copper foil, aluminum foil, nickel foil, etc.) current collector or a composite current collector. Compared with a metal foil current collector, the composite current collector has many advantages, such as improved the safety of battery and reduction of battery weight. However, in the process of using such a composite current collector, there are some problems: since the upper and lower metal layers of the composite current collector are not connected together, current conduction on only one side is realized after the composite current collector is welded with the existing tabs, while the opposite side welded with the existing tabs remains electronically insulated; therefore only half of the battery capacity is exerted.

Therefore, it is necessary to improve the structure of existing tabs such that the tabs can be used for a conventional metal foil (copper foil, aluminum foil, nickel foil, etc.) current collector lithium ion battery while the condition that the composite current collector lithium ion battery can exert full battery capacity is ensured.

### SUMMARY

One of the objectives of the present application is to provide a furcated tab, an electrode assembly and a battery, which would improve the structures of the furcated tab, electrode assembly and battery in the prior art, and effectively solve many problems in the prior art.

Some embodiments of the present application provide a furcated tab, the furcated tab includes a first furcated portion and a second furcated portion. The first furcated portion includes a first end, and the second furcated portion includes a second end. The second end is electrically connected to the first end.

The embodiments of the present application provide a furcated tab by changing the structure of the existing tab, which effectively solves the problem where a lithium ion battery does not exert full battery capacity thereof due to the presence of a non-metal layer when the existing tab is applied to a composite current collector. Meanwhile, the furcated tab provided by the embodiments of the present application can also be used in a lithium ion battery using a common monolithic metal current collector. In the latter case, the furcated tab provided by the embodiments of the present application not only simply replaces the existing tab, but also has the advantages of simplifying the process flow and increasing the energy density in a multi-tab battery.

According to some embodiments of the present application, the first end and the second end form an integrated structure.

According to some embodiments of the present application, the furcated tab further includes a sealing member. The sealing member is connected to the first end and the second end.

According to some embodiments of the present application, the first furcated portion further includes an extending portion extending outward from the first end. The furcated tab further includes a sealing member. The sealing member is connected to the extending portion of the first end. The first end of the first furcated portion is electrically connected to the second end of the second furcated portion by welding.

According to some embodiments of the present application, the furcated tab further includes a third furcated portion provided with a third end. The third end is electrically connected to the first end or the second end.

Some embodiments of the present application further provide an electrode assembly, the electrode assembly includes the furcated tab and a first current collector. The first furcated portion and the second furcated portion of the furcated tab are both electrically connected to the first current collector.

According to some embodiments of the present application, the first current collector includes a first metal layer, a second metal layer, and a non-metal layer located between the first metal layer and the second metal layer. The first furcated portion is electrically connected to the first metal layer, and the second furcated portion is electrically connected to the second metal layer.

According to some embodiments of the present application, the furcated tab further includes a first electrode. The first electrode further includes a first film and the first current collector. The first film is located on both sides of the first current collector. The first film includes a first blank region and a second blank region, a first portion of the first current collector and a second portion of the first current collector are respectively exposed by the first blank region and the second blank region. The first blank region and the second blank region refer to regions of the film where no film material exists. The first furcated portion is electrically connected to the first current collector of the first blank region, and the second furcated portion is electrically connected to the first current collector of the second blank region.

According to some embodiments of the present application, the first electrode includes a film region and an uncovered foil region. The uncovered foil region exposes the first current collector. The first furcated portion and the second furcated portion are respectively electrically connected to the first metal layer and the second metal layer of the first current collector at the uncovered foil region.

According to some embodiments of the present application, the first current collector is a monolithic metal current collector. The first furcated portion is electrically connected to a first surface of the monolithic metal current collector, and the second furcated portion is electrically connected to a second surface, opposite to the first surface, of the monolithic metal current collector.

Some embodiments of the present application further provide a battery, the battery includes a battery case and the electrode assembly.

### BRIEF DESCRIPTION OF THE DRAWINGS

The following will briefly illustrate the accompanying drawings necessary to describe the embodiments of the present application or the existing technology so as to facilitate the description of the embodiments of the present application. Obviously, the accompanying drawings described below are only part of the embodiments of the present application. For those skilled in the art, accompanying drawings of other embodiments can still be obtained according to the structures illustrated in the accompanying drawings without any creative effort.

FIG. 1 is a front view of a furcated tab according to some embodiments of the present application.

FIG. 2 is a right side view of the furcated tab as shown in FIG. 1.

FIG. 3 is a front view of the furcated tab shown in FIG. 1 and FIG. 2 electrically connected to a composite current collector.

FIG. 4 is a right side view of the furcated tab shown in FIG. 1 and FIG. 2 electrically connected to the composite current collector.

FIG. 5 is a front view of a furcated tab according to other embodiments of the present application.

FIG. 6 is a front view of the furcated tab shown in FIG. 5 electrically connected to the composite current collector.

FIG. 7 is a front view of a furcated tab according to other embodiments of the present application.

FIG. 8 is a right side view of the furcated tab shown in FIG. 7 electrically connected to the composite current collector.

FIG. 9 is a schematic view of the furcated tab shown in FIG. 1 and FIG. 2 electrically connected to the uncovered foil region of an electrode.

FIG. 10 is a schematic view of the furcated tab shown in FIG. 1 and FIG. 2 electrically connected to the film region of an electrode.

FIG. 11 is a side view of a furcated tab, provided with a multifurcated structure, electrically connected to a current collector according to other embodiments of the present application.

FIG. 12 is a side view of the furcated tab, provided with the multifurcated structure, electrically connected to the current collector according to other embodiments of the present application.

FIG. 13 is a side view of a multifurcated tab, provided with a multifurcated structure, electrically connected to a current collector according to other embodiments of the present application.

FIG. 14 is a structural schematic view of an electrode suitable for a multifurcated tab according to other embodiments of the present application.

FIG. 15 is a structural schematic view of an electrode suitable for a multifurcated tab according to other embodiments of the present application.

### DETAILED DESCRIPTION

The embodiments of the present application will be described in detail below. Throughout the specification, the same or similar components and components having the same or similar functions are denoted by similar reference numerals. The embodiments described herein with respect to the accompanying drawings are illustrative and graphical, and are used for providing a basic understanding on the present application. The embodiments of the present application should not be construed as limiting the present application.

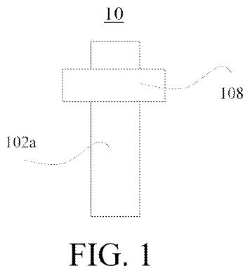

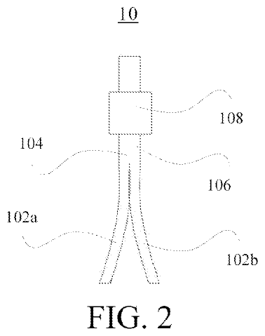

FIG. 1 is a front view of a furcated tab according to some embodiments of the present application. FIG. 2 is a right side view of the furcated tab as shown in FIG. 1.

FIG. 1 and FIG. 2 show a furcated tab 10 having an up furcation and a down furcation. As shown in FIG. 1 and FIG. 2, the furcated tab 10 includes a first furcated portion 102a and a second furcated portion 102b. The first furcated portion 102a includes a first end 104, and the second furcated portion 102b includes a second end 106. The first end 104 is electrically connected to the second end 106. The electrical connection manner between the first end 104 and the second end 106 is, but is not limited to, welding or the like. Further, as shown in FIG. 1 and FIG. 2, the furcated tab 10 further includes a sealing member 108. The sealing member 108 is connected to the first end 104 and the second end 106. After the furcated tab 10 is electrically connected to an electrode assembly (not shown), the sealing member 108 is used to prevent an electrolyte in the electrode assembly from flowing outward.

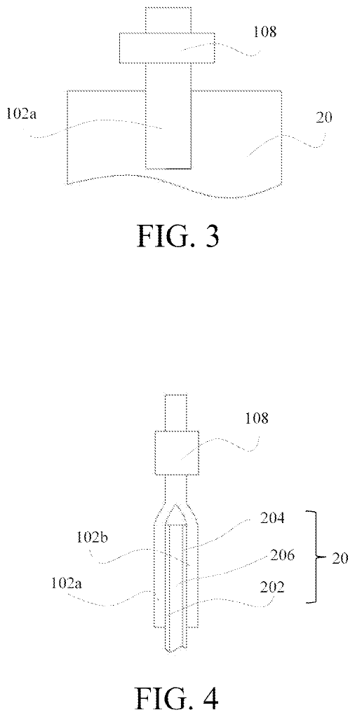

FIG. 3 is a front view of the furcated tab shown in FIG. 1 and FIG. 2 electrically connected to a composite current collector. FIG. 4 is a right side view of the furcated tab shown in FIG. 1 and FIG. 2 electrically connected to the composite current collector.

As shown in FIG. 3 and FIG. 4, the composite current collector 20 includes a first metal layer 202, a second metal layer 204, and a non-metal layer 206 located between the first metal layer 202 and the second metal layer 204. In one embodiment of the present application, the non-metal layer 206 is a high-molecular material. The first furcated portion 102a of the furcated tab 10 is electrically connected to the first metal layer 202 of the composite current collector 20, and the second furcated portion 102b of the furcated tab 10 is electrically connected to the second metal layer 204 of the composite current collector 20.

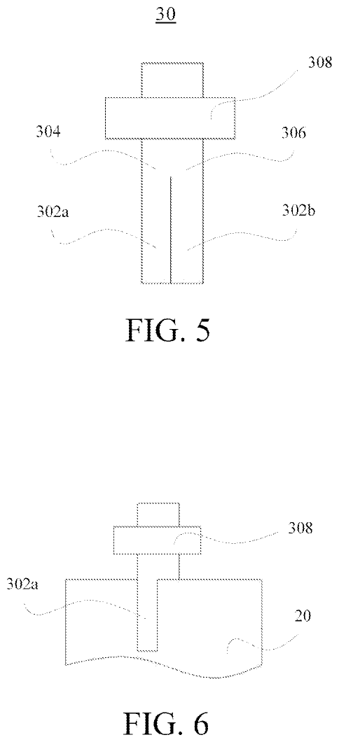

FIG. 5 is a front view of a furcated tab according to other embodiments of the present application.

FIG. 5 shows a furcated tab 30 having a left furcation and a right furcation. As shown in FIG. 5, the furcated tab 30 includes a first furcated portion 302a and a second furcated portion 302b. A first end 304 of the first furcated portion 302a is electrically connected to a second end 306 of the second furcated portion 302b. A sealing member 308 is connected to the first end 304 and the second end 306.

FIG. 6 is a front view of the furcated tab shown in FIG. 5 electrically connected to the composite current collector.

As shown in FIG. 6, the furcated tab 30 is electrically connected to the composite current collector 20. Specifically, similar to the electrical connection manner between the furcated tab 10 and the composite current collector 20 shown in FIG. 4, the first furcated portion 302a of the furcated tab 30 is electrically connected to the first metal layer 202 of the composite current collector 20, the second furcated portion 302b is electrically connected to the second metal layer 204 of the composite current collector 20, and details are not described herein.

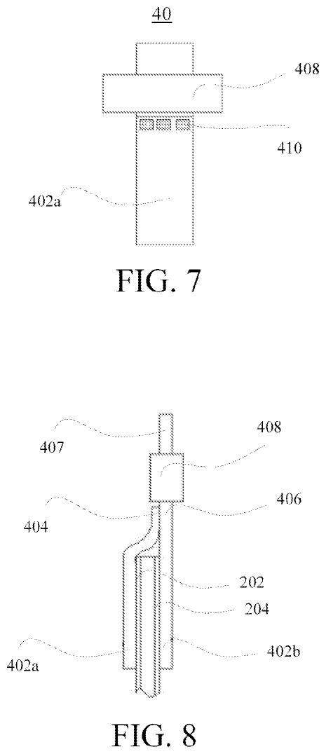

FIG. 7 is a front view of a furcated tab according to other embodiments of the present application. FIG. 8 is a right side view of the furcated tab shown in FIG. 7 electrically connected to the composite current collector.

FIG. 7 and FIG. 8 show a furcated tab having a long furcation and a short furcation. As shown in FIG. 7 and FIG. 8, the furcated tab 40 includes a first furcated portion 402a and a second furcated portion 402b. A first end 404 of the first furcated portion 402a is electrically connected to a second end 406 of the second furcated portion 402b. Preferably, the first end 404 of the first furcated portion 402a is electrically connected to the second end 406 of the second furcated portion 402b by welding. A plurality of welding joints 410 are shown in FIG. 7. The number of the welding joints 410 is determined according to actual needs, and is not limited herein. The first furcated portion 402a of the furcated tab 40 also includes an extending portion 407 extending outward from the second end 406. The sealing member 408 is connected to the extending portion 407. The first furcated portion 402a of the furcated tab 40 is electrically connected to the first metal layer 202 of the composite current collector 20, and the second furcated portion 402b of the furcated tab 40 is electrically connected to the second metal layer 204 of the composite current collector 20.

It should be understood that the first end 404 of the first furcated portion 402a and the second end 406 of the second furcated portion 402b are interchangeably adjusted. For example, the position of the extending portion 407 can be disposed to extend outward from the first end 404 without extending outward from the second end 406 shown in FIG. 8, and those skilled in the art can make adjustments according to actual needs.

According to other embodiments of the present application, the electrical connection manner of the furcated tabs 10, 30 and 40 shown in FIG. 1 to FIG. 8 to the composite current collector 20 is, but not limited to, ultrasonic welding, conductive adhesive welding, brazing, riveting, etc. Preferably, the electrical connection manner of the furcated tabs 10, 30 and 40 to the composite current collector 20 is ultrasonic welding.

It should be understood that although the furcated tabs shown in FIG. 1 to FIG. 8 are of a split structure, in other embodiments of the present application, the furcated tab is a single piece integrated structure. Taking the furcated tab 10 having an up furcation and a down furcation disclosed in FIG. 1 to FIG. 4 as an example, the first end 104 and the second end 106 are an integrated structure. Specifically, an end of a conventional tab is furcated up and down into the first furcated portion 102a and the second furcated portion 102b while the structure of the other end is kept unchanged, thereby obtaining the furcated tab 10 of which the first end 104 and the second end 106 are integrated. Correspondingly, an end of a conventional tab is furcated left and right into the first furcated portion 302a and the second furcated portion 302b while the structure of the other end is kept unchanged, thereby obtaining the furcated tab 30 having a left furcation and a right furcation, of which the first end 304 and the second end 306 are integrated, as shown in FIG. 5 and FIG. 6. The manufacturing method of the integrated furcated tab 40 having a long furcation and a left furcation is similar to that of the above two furcated tabs 10 and 30, and will not be described herein.

It should be understood that although FIG. 1 to FIG. 8 describe the case where the furcated tabs 10, 30 and 40 are used for the composite current collector 20, those skilled in the art will appreciate that the furcated tabs 10, 30 and 40 are also conveniently applied to a conventional monolithic metal current collector. When the furcated tabs 10, 30 and 40 provided by the embodiments of the present application are applied to a monolithic metal current collector, the first furcated portion and the second furcated portion of the furcated tabs 10, 30 and 40 are respectively electrically connected to two surfaces of the conventional monolithic metal current collector or simultaneously electrically connected to the same surface of the conventional monolithic metal current collector to direct flow on the current collector to the furcated tab.

An example that the furcated tab of the embodiments of the present application is connected to the electrode of the electrode assembly will be described below by way of some preferred embodiments.

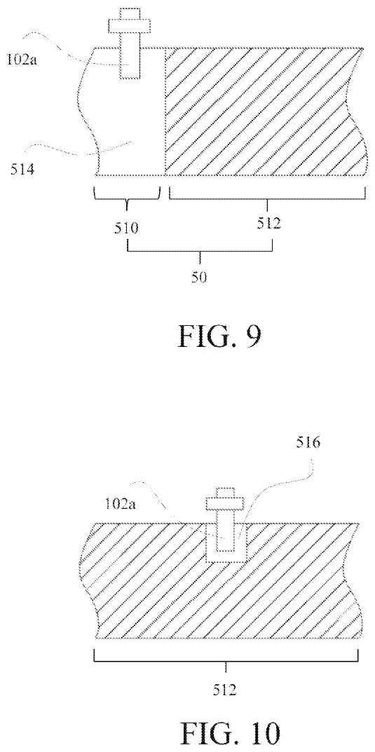

FIG. 9 is a schematic view of the furcated tab shown in FIG. 1 and FIG. 2 electrically connected to the uncovered foil region of an electrode.

As shown in FIG. 9, an electrode 50 includes an uncovered foil region 510 and a film region 512. The current collector 514 of the electrode 50 is exposed from the uncovered foil region 510 of the electrode 50. The first furcated portion 102a of the furcated tab 10 is electrically connected to the current collector 514, and the second furcated portion 102b (not shown) of the furcated tab 10 is also electrically connected to the current collector 514.

FIG. 10 is a schematic view of the furcated tab shown in FIG. 1 and FIG. 2 electrically connected to the film region of an electrode.

As shown in FIG. 10, the film region 512 of the electrode 50 includes a first blank region 516 exposing the current collector 514 and a second blank region (not shown) opposite the first blank region 516. The first furcated portion 102a of the furcated tab 10 is electrically connected to the first blank region 516, and the second furcated portion 102b is electrically connected to the second blank region (not shown). Although, the first blank region 516 and the second blank region (not shown) of the film shown in FIG. 10 are respectively located on two surfaces of the film region 512, those skilled in the art will appreciate that the first blank region 516 and the second blank region (not shown) of the film region 512 may be located on the same surface of the film region 512; and at this time, the first furcated portion 102a and the second furcated portion 102b of the furcated tab 10 are respectively electrically connected to the first blank region 516 and the second blank region (not shown) on the same surface of the film region 512. The first blank region 516 and the second blank region (not shown) are obtained by removing the film with laser cleaning, styrofoam or the like. The portion from which the film is removed is located at any position of the film region 512, and the preferred position is the mid-line region of the entire film region 512 in a longitudinal direction for reducing a electron transport path, thereby functioning to reduce the internal resistance.

It should be understood that although FIG. 9 and FIG. 10 only show schematic views of the furcated tab having an up furcation and a down furcation shown in FIG. 1 and FIG. 2 electrically connected to the uncovered foil region of an electrode and the film region of an electrode, those skilled in the art will appreciate that the furcated tab having a left furcation and a right furcation shown in FIG. 5 and FIG. 6 and the furcated tab having a long furcation and a left furcation shown in FIG. 7 and FIG. 8 are connected in a similar manner to the uncovered foil region of the electrode and the film region of the electrode, and details are not described herein.

FIG. 11 to FIG. 13 are side views of a furcated tab, provided with a multifurcated structure, electrically connected to a current collector according to other embodiments of the present application.

FIG. 11 shows an up-and-down furcated tab provided with a trifurcated structure. As shown in FIG. 11, the furcated tab 60 includes a first furcated portion 602a, a second furcated portion 602b and a third furcated portion 602c. A first end 604 of the first furcated portion 602a, a second end 605 of the second furcated portion 602b and a third end 606 of the third furcated portion 602c are connected together. A sealing member 608 is connected to the first end 604, the second end 605 and the third end 606. The first furcated portion 602a is electrically connected to a current collector 514a, the third furcated portion 602c is electrically connected to a current collector 514b, and the second furcated portion 602b is electrically connected to the current collector 514a and the current collector 514b at the same time.

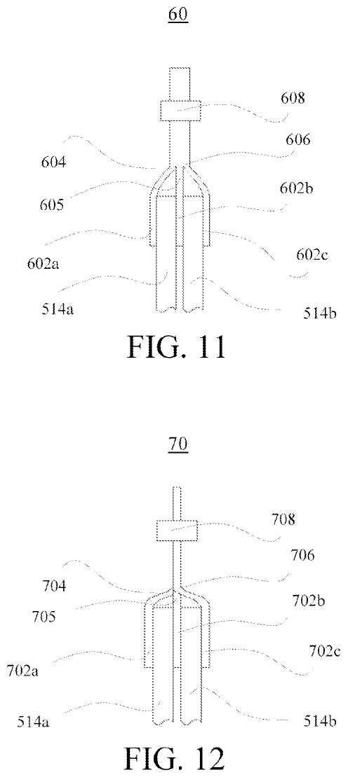

FIG. 12 shows a left-and-right furcated tab provided with a trifurcated structure. As shown in FIG. 12, the furcated tab 70 includes a first furcated portion 702a, a second furcated portion 702b and a third furcated portion 702c. A first end 704 of the first furcated portion 702a, a second end 705 of the second furcated portion 702b and a third end 706 of the third furcated portion 702c are connected together. A sealing member 708 is connected to the first end 704, the second end 705 and the third end 706. The first furcated portion 702a is electrically connected to the current collector 514a, the third furcated portion 702c is electrically connected to the current collector 514b, and the second furcated portion 702b is electrically connected to the current collector 514a and the current collector 514b at the same time.

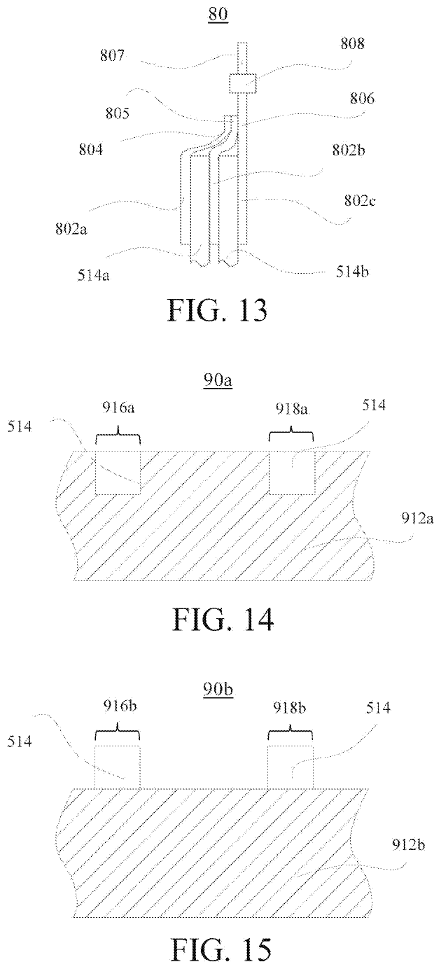

FIG. 13 shows a long-and-short furcated tab provided with a trifurcated structure. As shown in FIG. 13, the furcated tab 80 includes a first furcated portion 802a, a second furcated portion 802b and a third furcated portion 802c. A first end 804 of the first furcated portion 802a, a second end 805 of the second furcated portion 802b and a third end 806 of the third furcated portion 802c are electrically connected together. Preferably, the first end 804 of the first furcated portion 802a, the second end 805 of the second furcated portion 802b and the third end 806 of the third furcated portion 802c are electrically connected by welding. The third furcated portion 802c of the furcated tab 80 also includes an extending portion 807 extending outward from the third end 806, and a sealing member 808 is connected to the extending portion 807. The first furcated portion 802a of the furcated tab 80 is electrically connected to the current collector 514a, the third furcated portion 802c of the furcated tab 80 is electrically connected to the current collector 514b, and the second furcated portion 802b of the furcated tab 80 is electrically connected to the current collectors 514a and 514b.

It should be understood that the first end 804 of the first furcated portion 802a and the third end 806 of the third furcated portion 802c are interchangeably adjusted. For example, the position of the extending portion 807 is changed to be disposed to extend outward from the first end 804 without extending outward from the third end 806 shown in FIG. 13, and those skilled in the art make adjustments according to actual needs.

Although the specific types of the current collectors 514, 514a and 514b are not explicitly indicated in FIG. 11 to FIG. 13, those skilled in the art will appreciate that the current collectors 514, 514a and 514b are conventional monolithic metal current collectors and/or composite current collectors. The specific types of the current collectors 514, 514a and 514b are determined according to the actual needs of those skilled in the art.

It can also be seen from FIG. 11 to FIG. 13 that compared with the existing tab, the furcated tab of the embodiments of the present application simplifies the process flow and increases the energy density in a multi-tab battery.

In addition, those skilled in the art will also appreciate that although the above-mentioned FIG. 1 to FIG. 13 respectively describe the furcated tabs provided with a bifurcated structure and a trifurcated structure, the above are only some example embodiments of the present application, and those skilled in the art completely set the furcated tab provided with a more-furcated structure as needed. In addition, the form of the furcation is not limited to the up-and-down furcation, the left-and-right furcation and the long-and-short furcation, and can be other furcation forms, which will not be described again.

FIG. 14 to FIG. 15 are structural schematic views of a electrode suitable for a multifurcated tab according to other embodiments of the present application.

In FIG. 14, two blank regions 916a and 918a are cleaned from the film region 912a of a multi-tab electrode 90a, and the blank regions 916a and 918a expose the current collector 514. In FIG. 15, two blank regions 916b and 918b are cut from the periphery of the film region 912b of the multi-tab electrode 90b, and the blank regions 916b and 918b expose the current collector 514. After the electrodes 90a and 90b shown in FIG. 14 and FIG. 15 are wound into an electrode assembly, at the positions exposing the current collector 514, the multifurcated tab provided in the embodiments of the present application is electrically connected thereto to form a battery. Thus, the conventional exposed die-cut tabs are replaced by the built-in blank regions 916a and 918a or 916b and 918b, and the electrode assembly after winding is electrically connected to the multifurcated tab provided in the embodiments of the present application, thereby eliminating the process of folding the tabs, and saving the head space of the electrode assembly, thus increasing the volume energy density of the electrode assembly.

The furcated tab provided by the embodiments of the present invention may be used for both a common monolithic metal current collector and a composite current collector. When used in a common monolithic metal current collector, the furcated tab not only simply replaces the existing tab, but also has the advantages of simplifying the process flow and increasing the energy density. When used in a composite current collector, the furcated tab solves the problem that the composite current collector lithium ion battery only exerts half of the battery capacity.

Only comparative examples, embodiments, test methods and test results of the electrode assembly according to the embodiments of the present invention when the composite current collector is used will be described below. The test methods of the electrode assembly using a common monolithic metal current collector are similar, and will not be described here.

### COMPARATIVE EXAMPLE

Preparation of cathode plate: a composite current collector (12μ polyethylene terephthalate (PET)+double-sided 1μ Al) was used as a cathode current collector, and an active material of lithium cobalt oxide was uniformly coated on the front and back sides of the current collector. After the cathode plate was dried, slitting and cutting were performed, so that the cathode plate had a width of 79 mm and a total length of 889 mm, and the uncovered foil regions on the two sides of the head had a length of 43 mm. In the uncovered foil regions, a common negative electrode tab was ultrasonically welded to a position 25 mm from the film region to obtain the cathode plate.

Preparation of anode plate: common copper foil was used as an anode current collector, an active material of graphite was uniformly coated on the current collector, dried and cold-pressed, and slitting and cutting were performed to obtain the anode plate with a width of 81 mm and a total length of 805 mm. The uncovered foil regions on the two sides had a total length of 57.5 mm. In the uncovered foil region, a common positive electrode tab was welded to a position 46.5 mm from the film to obtain the anode plate.

Preparation of electrode assembly: a separator was placed between the corresponding cathode plate and anode plate, and the electrode assembly was formed by winding. The electrode assembly was subjected to electrolyte injection, packaging and formation to form the electrode assembly of the comparative example.

In the comparative example above, the existing tab and composite current collector were used to prepare the electrode assembly.

The following embodiments 1-3 are the cases where the furcated tab provided by the embodiments of the present application is electrically connected to the uncovered foil region of the electrode (for example, as shown in FIG. 9 of the present application).

### Embodiment 1

Preparation of cathode plate: a composite current collector (12μ polyethylene terephthalate (PET)+double-sided 1μ Al) was used as a cathode current collector, and an active material of lithium cobalt oxide was uniformly coated on the front and back sides of the current collector. After the cathode plate was dried, slitting and cutting were performed, so that the cathode plate had a width of 79 mm and a total length of 889 mm, and the uncovered foil regions on the two sides of the head had a length of 43 mm. In the uncovered foil region, an integrated up-and-down furcated tab was ultrasonically welded to a position 25 mm from the film region to obtain the cathode plate.

Preparation of anode plate: same as the anode plate used in the comparative example.

Preparation of electrode assembly: a separator was placed between the corresponding cathode plate and anode plate, and the electrode assembly was formed by winding. The dry electrode assembly was subjected to electrolyte injection, packaging and formation to form the electrode assembly of Embodiment 1.

In Embodiment 1 above, the composite current collector and the furcated tab 10 in FIG. 1 to FIG. 4 of the present application were used to prepare the electrode assembly.

### Embodiment 2

Preparation of cathode plate: a composite current collector (12μ polyethylene terephthalate (PET)+double-sided 1μ Al) was used as a cathode current collector, and an active material of lithium cobalt oxide was uniformly coated on the front and back sides of the current collector. After the cathode plate was dried, slitting and cutting were performed, so that the cathode plate had a width of 79 mm and a total length of 889 mm, and the uncovered foil regions on the two sides of the head had a length of 43 mm. In the uncovered foil region, an integrated left-and-right furcated tab was ultrasonically welded to a position 25 mm from the film region to obtain the cathode plate.

Preparation of anode plate: same as the anode plate used in the comparative example.

Preparation of electrode assembly: a separator was placed between the corresponding cathode plate and anode plate, and the electrode assembly was formed by winding. The electrode assembly was subjected to electrolyte injection, packaging and formation to form the electrode assembly of Embodiment 2.

In Embodiment 2 above, the composite current collector and the furcated tab 30 in FIG. 5 to FIG. 6 of the present application were used to prepare the electrode assembly.

### Embodiment 3

Preparation of cathode plate: a composite current collector (12μ polyethylene terephthalate (PET)+double-sided 1μ Al) was used as a cathode current collector, and an active material of lithium cobalt oxide was uniformly coated on the front and back sides of the current collector. After the cathode plate was dried, slitting and cutting were performed, so that the cathode plate had a width of 79 mm and a total length of 889 mm, and the uncovered foil regions on the two sides of the head had a length of 43 mm. In the uncovered foil region, an integrated long-and-short furcated tab was ultrasonically welded to a position 25 mm from the film region to obtain the cathode plate.

Preparation of anode plate: same as the anode plate used in the comparative example.

Preparation of electrode assembly: a separator was placed between the corresponding cathode plate and anode plate, and the electrode assembly was formed by winding. The electrode assembly was subjected to electrolyte injection, packaging and formation to form the electrode assembly of Embodiment 3.

In Embodiment 3 above, the composite current collector and the furcated tab 40 in FIG. 7 to FIG. 8 of the present application were used to prepare the electrode assembly.

The following embodiments 4-6 are the cases where the furcated tab provided by the embodiments of the present application is electrically connected to the film region of the electrode (for example, as shown in FIG. 10 of the present application).

### Embodiment 4

Preparation of cathode plate: a composite current collector (12μ polyethylene terephthalate (PET)+double-sided 1μ Al) was used as a cathode current collector, and an active material of lithium cobalt oxide was uniformly coated on the front and back sides of the current collector. After the cathode plate was dried, slitting and cutting were performed, so that the cathode plate had a width of 79 mm and a total length of 889 mm, and the uncovered foil region on the two sides of the head had a length of 43 mm. In the film region, a region was laser-cleaned at a position 414 mm from the edge of the film region, and an integrated up-and-down furcated tab was ultrasonically welded thereon to obtain the cathode plate.

Preparation of anode plate: common copper foil was used as an anode current collector, an active material of graphite was uniformly coated on the current collector, dried and cold-pressed, and slitting and cutting were performed to obtain the anode plate with a width of 81 mm and a total length of 805 mm. The uncovered foil regions on the two sides had a total length of 57.5 mm. In the film region, a region was laser-cleaned at a position 332 mm from the edge of the film region, and a common positive electrode tab was ultrasonically welded thereon to obtain the anode plate.

Preparation of electrode assembly: a separator was placed between the corresponding cathode plate and anode plate, and the electrode assembly was formed by winding. The electrode assembly was subjected to electrolyte injection, packaging and formation to form the electrode assembly of Embodiment 4.

In Embodiment 4 above, the composite current collector and the furcated tab 10 in FIG. 1 to FIG. 4 of the present application were used to prepare the electrode assembly.

### Embodiment 5

Preparation of cathode plate: a composite current collector (12μ polyethylene terephthalate (PET)+double-sided 1μ Al) was used as a cathode current collector, and an active material of lithium cobalt oxide was uniformly coated on the front and back sides of the current collector. After the cathode plate was dried, slitting and cutting were performed, so that the cathode plate had a width of 79 mm and a total length of 889 mm, and the uncovered foil regions on the two sides of the head had a length of 43 mm. In the film region, a region was laser-cleaned at a position 414 mm from the edge of the film region, and an integrated left-and-right furcated tab was ultrasonically welded thereon to obtain the cathode plate.

Preparation of anode plate: common copper foil was used as an anode current collector, an active material of graphite was uniformly coated on the current collector, dried and cold-pressed, and slitting and cutting were performed to obtain the anode plate with a width of 81 mm and a total length of 805 mm. The uncovered foil regions on the two sides had a total length of 57.5 mm. In the film region, a region was laser-cleaned at a position 332 mm from the edge of the film region, and a common positive electrode tab was ultrasonically welded thereon to obtain the anode plate.

Preparation of electrode assembly: a separator was placed between the corresponding cathode plate and anode plate, and the electrode assembly was formed by winding. The electrode assembly was subjected to electrolyte injection, packaging and formation to form the electrode assembly of Embodiment 5.

In Embodiment 5 above, the composite current collector and the furcated tab 30 in FIG. 5 to FIG. 6 of the present application were used to prepare the electrode assembly.

### Embodiment 6

Preparation of cathode plate: a composite current collector (12μ polyethylene terephthalate (PET)+double-sided 1μ Al) was used as a cathode current collector, and an active material of lithium cobalt oxide was uniformly coated on the front and back sides of the current collector. After the cathode plate was dried, slitting and cutting were performed, so that the cathode plate had a width of 79 mm and a total length of 889 mm, and the uncovered foil region on the two sides of the head had a length of 43 mm. In the film region, a region was laser-cleaned at a position 414 mm from the edge of the film region, and an integrated long-and-short furcated tab was ultrasonically welded thereon to obtain the cathode plate.

Preparation of anode plate: common copper foil was used as an anode current collector, an active material of graphite was uniformly coated on the current collector, dried and cold-pressed, and slitting and cutting were performed to obtain the anode plate with a width of 81 mm and a total length of 805 mm. The uncovered foil region on the two sides had a total length of 57.5 mm. In the film region, a region was laser-cleaned at a position 332 mm from the edge of the film region, and a common positive electrode tab was ultrasonically welded thereon to obtain the anode plate.

Preparation of electrode assembly: a separator was placed between the corresponding cathode plate and anode plate, and the electrode assembly was formed by winding. The electrode assembly was subjected to electrolyte injection, packaging and formation to form the electrode assembly of Embodiment 6.

In Embodiment 6 above, the composite current collector and the furcated tab 40 in FIG. 7 to FIG. 8 of the present application were used to prepare the electrode assembly.

The capacity of the electrode assemblies and the resistance of the cathode current collector obtained in the comparative example and Embodiments 1-6 above were measured below.

The specific test and measurement methods are as follows:

1. The electrode assembly was charged with a current of 0.2C to a fully charged state and to 0.02C at constant voltage (CV) to obtain the capacity of the electrode assembly.

2. The resistance of the cathode current collector was calculated by Ohm's law.

The test results are shown in Table 1 below.

TABLE 1

| | Capacity | Resistance of |
|---|---|---|
| | Exerted | Cathode Current |
| | (mAh) | Collector (mohm) |
| Comparative | 1750 | 78 |
| Example | | |
| Embodiment 1 | 3700 | 39 |
| Embodiment 2 | 3700 | 39 |
| Embodiment 3 | 3700 | 39 |
| Embodiment 4 | 3700 | 39 |
| Embodiment 5 | 3700 | 39 |
| Embodiment 6 | 3700 | 39 |

It can be seen from Table 1 that, for the electrode assembly of the comparative example and the electrode assemblies of Embodiments 1-6 provided with the same composite current collector, the electrode assemblies using the furcated tabs provided by the embodiments of the present application exert more than double the capacity of the electrode assembly using the existing tab. In addition, it can also be seen from Table 1 that the electrode assemblies provided in Embodiments 1-6 have a resistance of the cathode current collector resistance which is only half of a resistance of the cathode current collector provided in comparative example.

The above description summarizes the features of several embodiments, which enables those of ordinary skill in the art to understand the various aspects of the present application. Those of ordinary skill in the art can readily use the present application as a basis for designing or modifying other compositions to achieve the same objectives and/or the same advantages as the embodiments herein. It is also to be understood by those of ordinary skill in the art that these equal examples do not depart from the spirit and scope of the present application, and it is possible to make various changes, substitutions and modifications to the present application without departing from the spirit and scope of the present application. Although the methods disclosed herein have been described with reference to the specific operations that are performed in a specific order, it should be understood that these operations can be combined, subdivided, or reordered to form an equivalent method without departing from the teachings of the present application. Therefore, unless otherwise specifically indicated herein, the order and grouping of operations shall not be construed as any limitation on the present application.

What is claimed is:

1. A furcated tab, comprising:
a first furcated portion, provided with a first end; and
a second furcated portion, provided with a second end; wherein the second end is electrically connected to the first end.

2. The furcated tab according to claim 1, wherein the first end and the second end are of an integrated structure.

3. The furcated tab according to claim 1, wherein the furcated tab further comprises a sealing member, the sealing member is connected to the first end and the second end.

4. The furcated tab according to claim 1, wherein the first furcated portion further comprises an extending portion, the extending portion extends outward from the first end.

5. The furcated tab according to claim 4, wherein the furcated tab further comprises a sealing member, the sealing member is connected to the extending portion.

6. The furcated tab according to claim 5, wherein the first end and the second end are welded together.

7. The furcated tab according to claim 1, wherein the furcated tab further comprises a third furcated portion provided with a third end, and the third end is electrically connected to the first end or the second end.

8. An electrode assembly, comprising:
a furcated tab comprising a first furcated portion provided with a first end and a second furcated portion provided with a second end, wherein the second end is electrically connected to the first end; and
a first current collector;
wherein the first furcated portion and the second furcated portion are both electrically connected to the first current collector.

9. The electrode assembly according to claim 8, wherein the furcated tab further comprises a sealing member, the sealing member is connected to the first end and the second end.

10. The electrode assembly according to claim 8, wherein the first furcated portion further comprises an extending portion, the extending portion extends outward from the first end.

11. The electrode assembly according to claim 10, wherein the furcated tab further comprises a sealing member, the sealing member is connected to the extending portion.

12. The electrode assembly according to claim 8, wherein the furcated tab further comprises a third furcated portion provided with a third end, the third end is electrically connected to the first end or the second end.

13. The electrode assembly according to claim 8, wherein the first current collector comprises a first metal layer, a second metal layer, and a non-metal layer located between the first metal layer and the second metal layer.

14. The electrode assembly according to claim 13, wherein the first furcated portion is electrically connected to the first metal layer, and the second furcated portion is electrically connected to the second metal layer.

15. The electrode assembly according to claim 8, further comprising a first electrode, wherein the first electrode comprises the first current collector and a first film, the first film is located on both sides of the first current collector.

16. The electrode assembly according to claim 15, wherein the first film comprises a first blank region and a second blank region, a first portion of the first current collector and a second portion of the first current collector are respectively exposed by the first blank region and the second blank region; the first furcated portion is electrically connected to the first portion of the first current collector exposed by the first blank region, and the second furcated portion is electrically connected to the second portion of the first current collector exposed by the second blank region.

17. The electrode assembly according to claim 13, wherein the first electrode comprises a film region and an uncovered foil region exposing the first current collector, and the first furcated portion is electrically connected to the first metal layer of the first current collector at the uncovered foil region, and the second furcated portion is electrically connected to the second metal layer of the first current collector at the uncovered foil region.

18. The electrode assembly according to claim 8, wherein the first current collector is a monolithic metal current collector.

19. The electrode assembly according to claim 18, wherein the first furcated portion is electrically connected to a first surface of the monolithic metal current collector, and the second furcated portion is electrically connected to a second surface, opposite to the first surface, of the monolithic metal current collector.

20. A battery, comprising a battery case and an electrode assembly, wherein the electrode assembly comprises:
a furcated tab comprising a first furcated portion provided with a first end and a second furcated portion provided with a second end, wherein the second end is electrically connected to the first end; and
a first current collector;
wherein the first furcated portion and the second furcated portion are both electrically connected to the first current collector.
